(19) United States
(12) Patent Application Publication
(10) Pub. No.: US 2008/0083206 A1
(43) Pub. Date: Apr. 10, 2008

(54) Gearless rotary vegetation cutter

(76) Inventor: Miguel Gerardo Verduzco, Brownsville, TX (US)

Correspondence Address: STRASBURGER & PRICE, LLP, 901 MAIN STREET, SUITE 4400, DALLAS, TX, 75202, US

(21) Appl. No.: 11/897,206

(22) Filed: Aug. 29, 2007

Related U.S. Application Data
(60) Provisional application No. 60/850,364, filed on Oct. 6, 2006.

(51) Int. Cl. A01D 34/63; F16H 37/00

(52) U.S. Cl. 56/255; 74/11

(57) ABSTRACT

A gearless, clutchless agricultural rotary vegetation cutter includes a drive train having a tire which is attached to a power shaft which receives power from the PTO of a tractor. As the power shaft spins, it causes the tire to spin against a rotor plate. As the rotor spins in response to the spinning of the tire, the rotor plate causes a blade carrier to which cutting blades are attached to spin. The cutting blades then mow and shred the vegetation encountered. When an obstacle is encountered by the cutting blades which causes the blades to stop turning, the tire continues to turn on the rotor plate without resulting damage to the drive train or to the tractor.

### CROSS REFERENCE TO RELATED APPLICATIONS

This application claims the benefit of Provisional U.S. Patent Application No. 60/850,364, filed Oct. 6, 2006.

### STATEMENT REGARDING FEDERALLY FUNDED RESEARCH AND DEVELOPMENT

The invention described in this patent application was not the subject of federally sponsored research or development.

### FIELD

The invention described in this patent application pertains to an improvement in agricultural implements; more particularly, the present invention relates to a rotary vegetation cutter.

### BACKGROUND

As the population of the world grows, there is a continuing need to clear land of vegetation including weeds, bushes and tall grasses to grow crops. Clearing the land of weeds, bushes and tall grasses is also a necessary first step for building villages and developing pasture lands for animals.

It is a common sight during the warmer months of the year to see a tractor pulling a rotary vegetation cutter along the sides or along the median portion of highways to keep roadside grasses and underbrush under control. Rotary cutters pulled by tractors are also commonly used by many farmers and ranchers to: 1) keep their pastures free of unwanted weeds, 2) mow hay for later feeding of livestock, 3) cut up stubble left over after harvesting crops, and 4) clear new land for agricultural exploitation.

Large manufacturers of agricultural implements make rotary vegetation cutters in a variety of sizes. The common feature of rotary vegetation cutters is a mower head which includes one or more rotary blades. The speed of blade rotation is sufficient to enable the cutting of most vegetation encountered by the advancing edges of the rotating mower blades.

Prior art rotary vegetation cutters are typically attached to a tractor at two points. The first connection point is typically a simple tow hitch which is attached on one end to the rotary vegetation cutter and on the other end to the pull or tow connection on the back of the tractor for movement of the rotary vegetation cutter over the vegetation to be cut. The second connection point between the rotary vegetation cutter and the tractor is between the power take off (PTO) from the drive system of a tractor and the drive system for the rotary vegetation cutter. Rotational power to operate the rotary vegetation cutter is obtained from the power train of the tractor. The PTO of the tractor is typically mechanically attached to a gear box on prior art rotary vegetation cutters by way of a universal joint which, in turn, is connected to a power transfer shaft. The other end of the power transfer shaft is typically connected to the rotary vegetation cutter using a universal joint. When the tractor engine is at the appropriate RPM, the operator engages the PTO. The PTO turns at a speed commensurate with the RPM of the tractor engine. When the PTO turns, it turns the power shaft which, in turn, rotates the gears in the drive train of the prior art rotary vegetation cutter. The drive train portion of the prior art rotary vegetation cutter causes the blades of the rotary vegetation cutter to turn at a speed suitable to cut vegetation such as weeds, brush, or tall grasses.

A clutch assembly is frequently used in the drive train of rotary vegetation cutters. When the rotary vegetation cutter blades strike a hard object such as a stump or rock, the clutch assembly within the drive train disengages. This disengagement protects both the gear box of the prior art rotary vegetation cutter and the drive train of the tractor. However, in some circumstances, when the rotating blades strike a heavy or hard object and the clutch assembly does not properly disengage, damage to the drive train may occur. Such damage necessitates an expensive and time consuming repair to the rotary vegetation cutter. Such repair to the drive train of the rotary vegetation cutter may include replacement of gears, bearings or the entire gear box and clutch assembly. If the impact is of sufficient magnitude, the shock from striking a heavy or hard object could be transmitted to the tractor resulting in damage to the PTO connection and possibly to the drivetrain and/or engine of the tractor.

While prior art rotary vegetation cutters have reduced the amount of time needed to mow/shred vegetation, their initial purchase price or the cost of maintenance has put such mowers/shredders out of reach for many small farmers. Accordingly, there is a need in the art for an inexpensive mower/shredder which can be made both affordable for and easily repairable by small farmers.

What is needed in the art is a simple, inexpensive system and method by which a rotary vegetation cutter can be driven. Such system and method should be rapidly repairable if damaged when the mower blades strike a hard or immovable object.

### SUMMARY

The gearless agricultural rotary vegetation cutter disclosed in the instant application provides a simple, inexpensive rotary vegetation cutter drive system and method which protects the power train of the rotary vegetation cutter whenever the mower blades strike a hard or immovable object. Additionally, the disclosed system and method can be easily and quickly repaired if needed.

The power train of the disclosed gearless agricultural rotary vegetation cutter is inexpensive and easily repairable because the power train does not rely on a complex gear box or clutch assembly to transfer power from the tractor engine to the rotating mower blades. Instead, rotational power from the PTO of the tractor is transferred to a drive train whose key component is an inexpensive rubber automobile or truck tire. The rubber automobile or truck tire rotates when powered by a power transfer shaft connected to the PTO. As the rubber tire rotates against the top surface of a substantially flat rotor, the rotating friction between the outside of the rubber tire and the top of the substantially flat rotor causes the substantially flat rotor to turn.

The substantially flat rotor is mechanically connected to either a single blade or a rotatable blade carrier plate. Rotation of the single blade or rotatable blade carrier plate causes the single blade or the mower blades attached to the carrier plate to move at a speed which is sufficient to cut grass, stubble or other vegetation. When a blade edge strikes a hard or immovable object, the blade or the blades attached to the rotatable blade carrier plate and the substantially horizontal rotor may stop rotating but the rubber tire will continue to rotate by slipping against the surface of the substantially flat rotor. Accordingly, the use of a combination of the outside surface of a rubber tire turning against the surface of a substantially flat rotor plate which turns either a single blade or a rotating blade carrier plate enables three key mechanical functions using simple, inexpensive component. These functions are: a) mechanical alignment, b) power transfer, and c) disengagement without a complex and expensive gear box and clutch mechanism.

### BRIEF DESCRIPTION OF THE SEVERAL VIEWS OF THE DRAWINGS

A better understanding of the gearless rotary vegetation cutter of the present invention may be had by review of the following drawing figures wherein:

FIG. 1 is a perspective view of the disclosed gearless agricultural rotary vegetation cutter of the present invention;

FIG. 1A is a perspective view from underneath the rotary vegetation cutter looking up toward the tire;

FIG. 2 is a perspective view from the right side of the rotary vegetation cutter showing the drive mechanism and the power or drive shaft holding frame;

FIG. 3 is a perspective view from the left side of the rotary vegetation cutter showing the drive mechanism and the power or draft shaft holding frame;

FIG. 3A is a perspective view of the underside of the rotary vegetation cutter;

FIG. 3B is a perspective view from the right rear of the rotary vegetation cutter;

FIG. 3C is a perspective view from the back of the rotary vegetation cutter;

FIG. 4 is a perspective view from the front rotary vegetation cutter;

FIG. 4A is a perspective view from the left front of the rotary vegetation cutter;

FIG. 5 is a perspective view of the drive train of the gearless agricultural rotary vegetation cutter;

FIG. 5A is a perspective view of the connection between the rotor and the blade carrier;

FIG. 5B is a perspective view of the adjustable mounting system for the tire;

FIG. 5C is a perspective view of the underside of the rotary carrier showing the relationship of the tire to the blades; and

FIG. 6 is an exploded perspective view of the drive wheel, the rotor and the rotatable blade carrier body.

### DESCRIPTION OF THE EMBODIMENTS

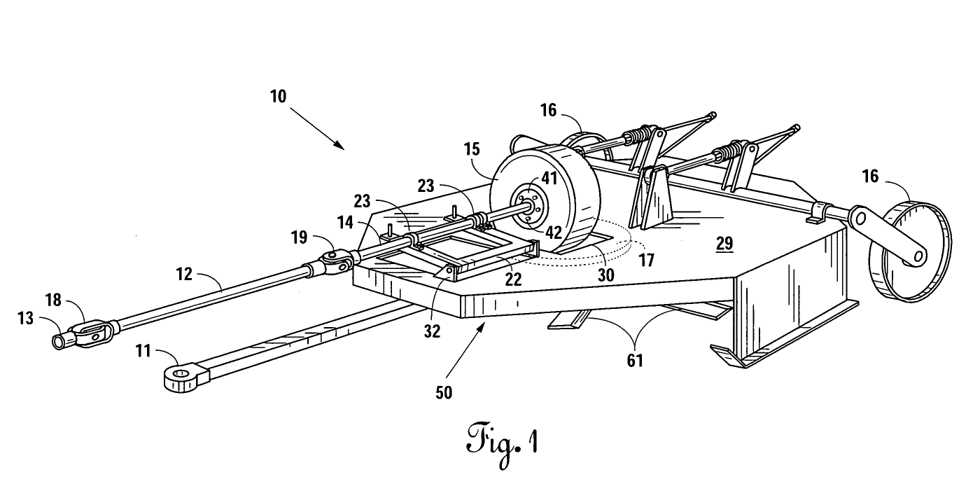

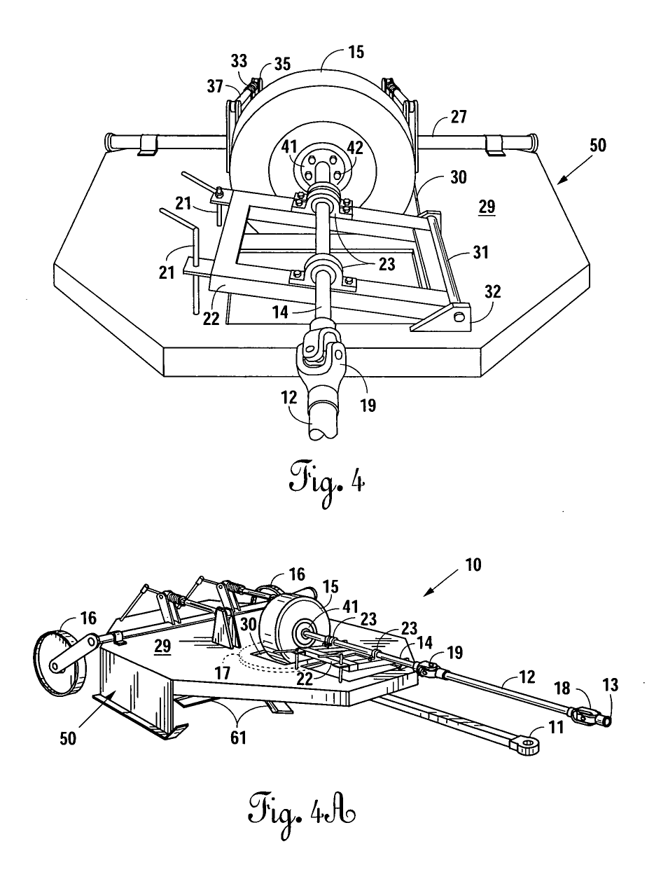

As shown in FIG. 1, FIG. 1A, FIG. 4A, and FIG. 6 the disclosed gearless rotary vegetation cutter 10 connects the PTO of a tractor [not shown] to a rotating blade cutting mechanism without the use of a complex and expensive prior art gearbox and clutch assembly. According to the present invention, power from the PTO of the tractor is used to rotate a substantially vertically oriented wheel 41 and tire 15 combination. The tire 15 is in rotating frictional, substantially perpendicular contact with the top surface of a shaft-mounted substantially flat, substantially horizontal rotor plate 17. The substantially flat, substantially horizontal rotor plate 17 spins about the central axis of mounting shaft 37 because of rotating frictional contact with the outer surface of the vertically oriented tire 15. Rotation of the rotor plate 17 causes a blade carrier assembly 52 to rotate. A plurality of sharpened blades 61 attached to the blade carrier body assembly 52 are then caused to rotate at a sufficient speed for cutting vegetation thereby resulting in the desired mowing/shredding of unwanted vegetation which is provided by the disclosed invention.

The gearless agricultural rotary vegetation cutter 10 is attached to the tractor at two points. The first attachment point is at the tow hitch 11. Attachment of the tractor at the tow hitch 11 of the rotary vegetation cutter 10 permits the tractor to pull the rotary vegetation cutter 10 through a field or over the vegetation in the area to be mowed. The second attachment point is the connection 13 between the gearless agricultural rotary vegetation cutter 10 and the PTO of the tractor. Herein a universal joint 18 is used together with the connection 13 to the PTO. When the tractor engine is at sufficient speed to operate the gearless rotary vegetation cutter 10 of the present invention, the operator can engage the PTO portion of the tractor. This engagement causes the PTO connection 13 to rotate which, in turn, causes a first power shaft 12 connected to the universal joint 18 to rotate. The first power shaft 12 is connected through another universal joint 19 to a second power shaft 14. The second power shaft 14 is connected at its distal end to a plate or a wheel 41 on which the tire 15 is mounted.

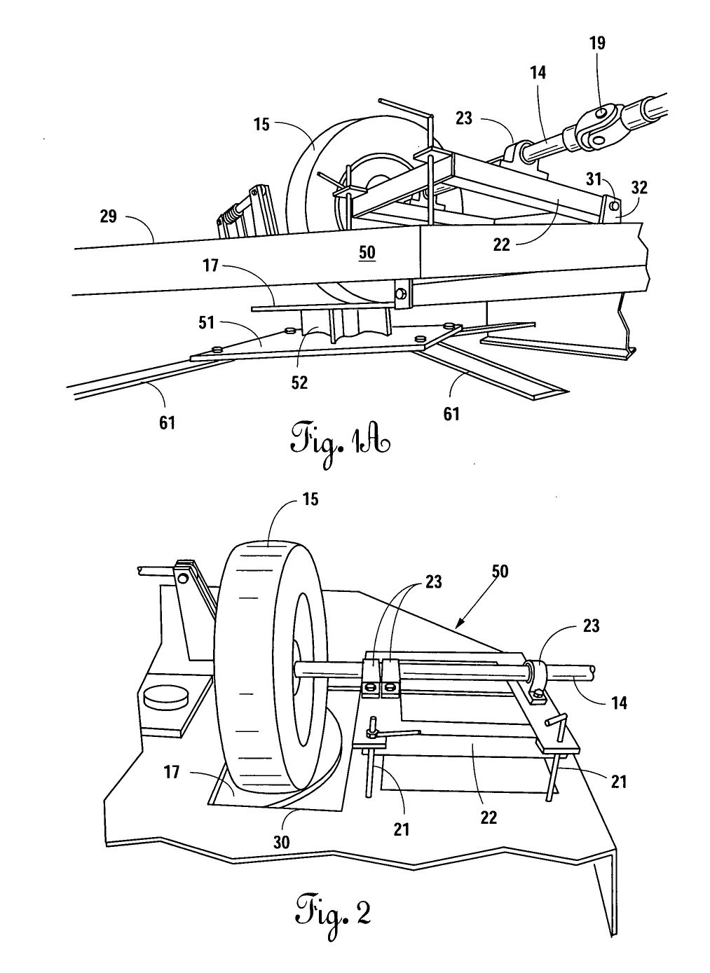

The second power shaft 14 is supported by a set of bearing blocks 23 as shown in FIG. 2. As the first power shaft 12 is rotated by the PTO connection 13 of the tractor, the rotational energy is transferred to the second power shaft 14 and, in turn, to the plate or wheel 41 and tire 15 combination. The plate or wheel 41 and tire 15 combination spin in concert with the rotation of the first power shaft 12 and PTO connection 13. The tire 15 is positioned by the plate or wheel 41 in a substantially vertical orientation against the upper surface of the substantially flat, substantially horizontal rotor plate 17 which turns from rotating frictional contact with the outside surface of the tire 15 as the tire 15 is rotated.

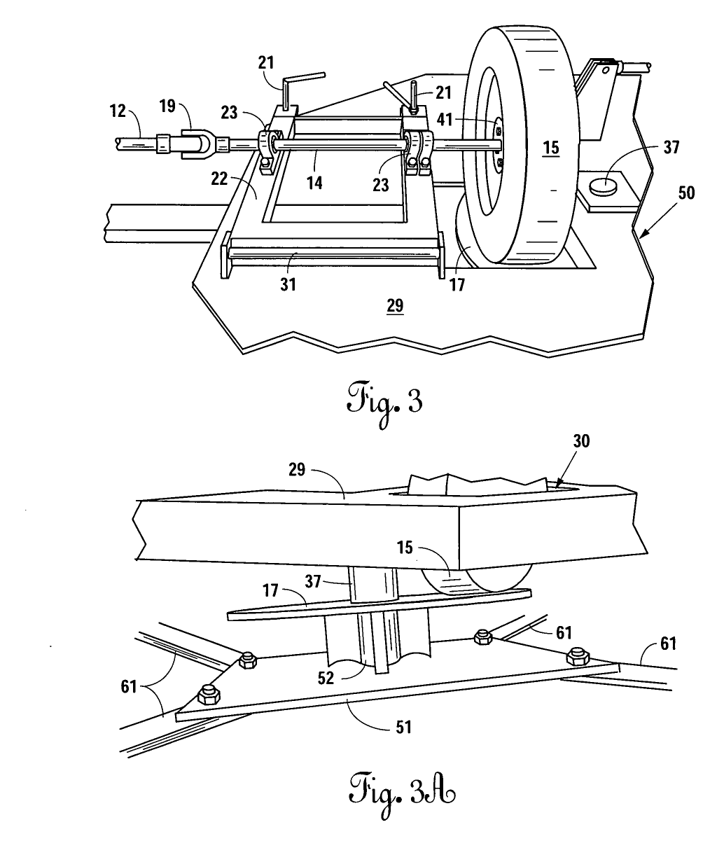

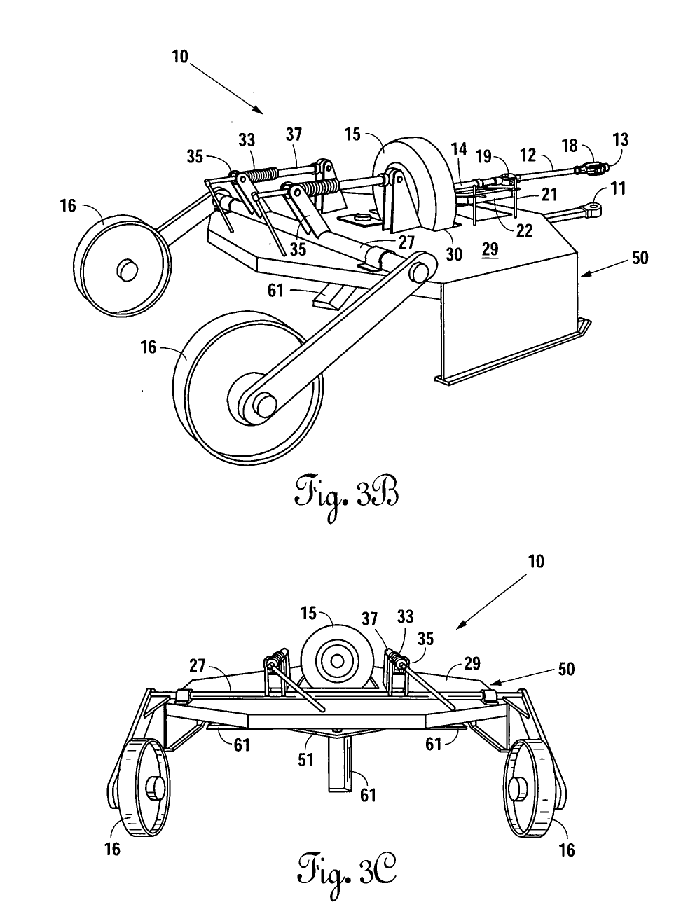

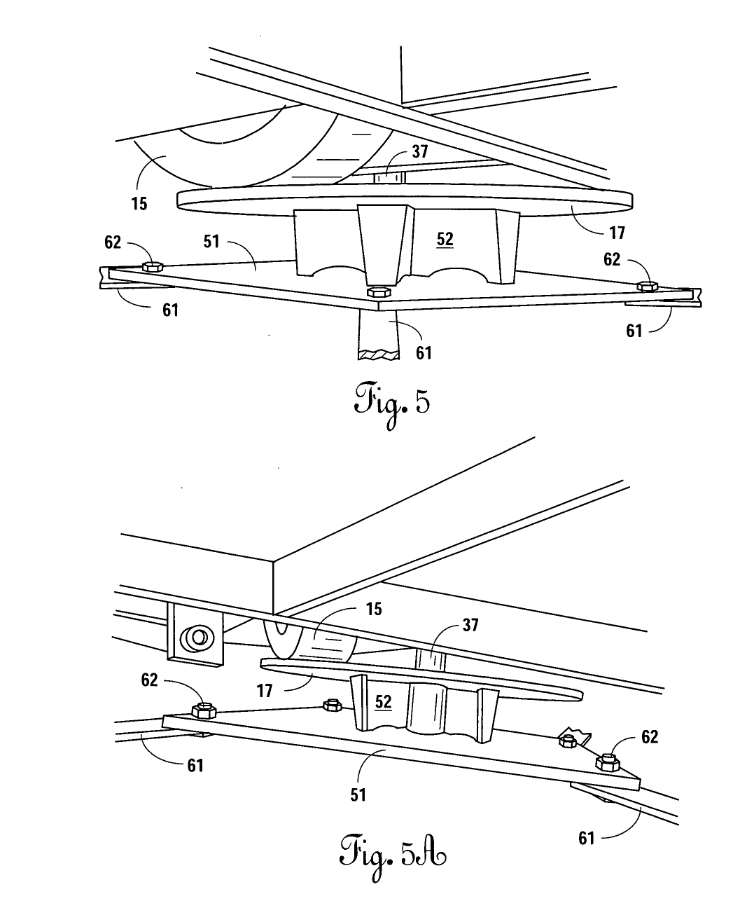

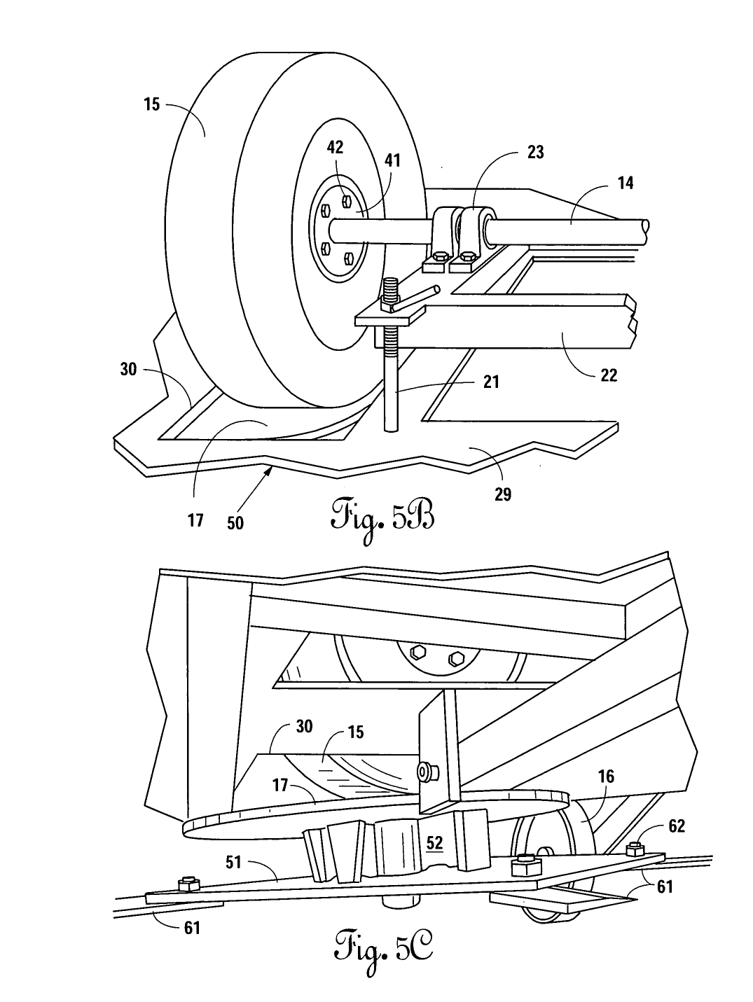

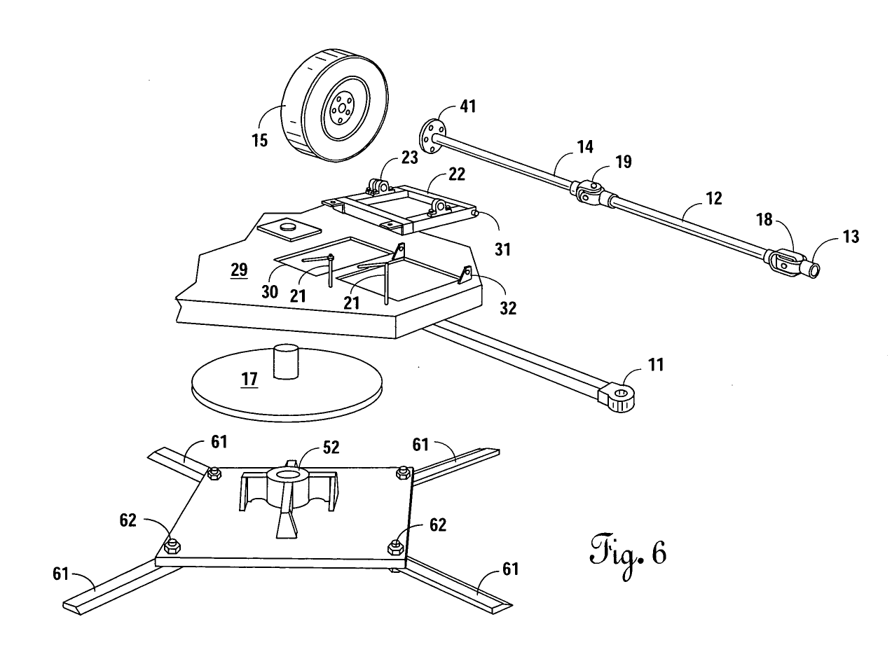

As shown in FIG. 3, FIG. 3A, FIG. 5, FIG. 5A and FIG. 5C, the rotor plate 17 includes a mounting shaft 37 which is directly connected to a blade carrier 51. Connected to the blade carrier 51, in the preferred embodiment, are four mower blades 61. As the rotor plate 17 turns so turns the blade carrier plate 51 and the four mower blades 61. The centrifugal force on the blades 61 causes the blades to extend outwardly from their mountings 62. The rotation of the blades 61 initiates the cutting and shredding of vegetation brought into contact with the advancing edge of each moving blade 61.

As shown in FIG. 3B and FIG. 3C, connected to the rear of the gearless rotary vegetation cutter 10 are two wheels 16 mounted on either end of a rotatable axle 27. For small rotary vegetation cutters, one wheel may be used. The rotatable axle 27 is rotatably mounted to the deck portion 29 of the housing assembly 50 under which the blades 61 rotate. The wheels 16 facilitate movement of the gearless rotary vegetation cutter 10 of the present invention across the area to be mowed. Further, the vertical orientation of the wheels 16 with respect to the height of the deck portion 29 of the housing assembly 50 is adjustable. Such adjustment enables the relative position of the cutting blades 61 with respect to the ground to be raised or lowered, thereby adjusting the cutting height of the vegetation over which the rotating blades 61 pass. The adjustment mechanism used to raise and lower the cutting height of the gearless agricultural rotary vegetation cutter 10 disclosed includes a simple mechanical spring 33 biased bracket 35 and adjustment arm 37 assembly. Other height adjustment assemblies well known to those of ordinary skill in the art may be used without departing from the scope of the disclosed invention.

The tire 15 is attached to the housing 50 by a power or drive shaft holding frame 22 as shown in FIG. 1A, FIG. 2, FIG. 3, FIG. 4A, and FIG. 5B. The power or drive shaft holding frame 22 is mounted to the deck 29 so that the outside surface of the tire 15 is in contact with the top of the rotor plate 17 through hole 30 formed in the deck 29. As previously indicated, the second power shaft 14 extending from the tire 15 to the universal joint 19 is supported by a set of bearing blocks 23 mounted to the holding drive shaft frame 22 in such a way as to permit the second power shaft 14 to rotate in conjunction with the PTO of the tractor. The power or drive shaft holding frame 22 is hingedly attached to the deck 29 by a metal rod 31 passing through the power or drive shaft holding frame and a part of mounting brackets 32 affixed to the deck 29. This mounting configuration for the drive shaft holding frame 22 acts as a hinge and permits the drive shaft holding frame 22 to be raised or lowered by rotation about the metal rod 31.

Opposite the hinged mounting, the other side of the drive shaft holding frame 22 is positioned with respect to the deck 29 by the use of large threaded fasteners 21. These large threaded fasteners 21 enable the operator to adjust the force applied to the top of the rotor plate 17 by the outside surface of the tire 15. As tread is worn from the outside surface of the tire 15 by operation of the gearless agricultural rotary vegetation cutter 10, the operator can simply apply more frictional force by the tire 15 on the top surface of the rotor plate 17 by adjusting the threaded fasteners 21. When the outside surface of the tire 15 becomes excessively worn and needs to be changed, the operator can remove the threaded fasteners 21, raise the drive shaft holding frame 22 and then replace the tire 15 with one having more rubber on its outside surface. It has been found that some tires found to be not serviceable for use on roads by vehicles may be used with the present invention. Further, it has been found that the amount of tread remaining on the tire has little effect on the operation of the present invention.

Attachment of the second power shaft 14 to the tire 15 is shown in FIG. 4 and FIG. 4A. Viewing the gearless agricultural rotary vegetation cutter from the perspective of the tractor operator, the attachment of the tire 15 to the distal end of the second power shaft 14 is accomplished by using lug nuts 42 of the type typically used to attach tires to a car or a truck by a method well known to those of ordinary skill in the art. However, in order to accomplish this attachment, a plate or wheel 41 with holes drilled in corresponding to the lug nut 42 installation points must be attached to the distal end of the power shaft 14. A common way to attach this plate or wheel 41 to the distal end of the second power shaft 14 is by welding the plate or wheel 41 to the end of the second power shaft 14.

As described above, as the plate or wheel portion 41 of the tire and wheel combination spins, the rotor plate 17, upon which the tire 15 is positioned, turns from rotating frictional contact. This, in turn, causes the rotatable blade carrier 51 affixed to the rotor plate 17 to turn. This arrangement is shown in FIG. 5. Rotation of the tire 15 caused ultimately by the PTO connection 13 causes the rotor plate 17 to turn. As shown in FIG. 3A the rotor plate 17 is securely and directly affixed to a blade carrier assembly 52 which includes a large, square blade carrier plate 51. In the preferred embodiment, four cutting blades 61 are attached at the corners of the blade carrier plate 51. Those of ordinary skill in the art will understand that other shapes of blade carrier plates and other numbers of blades may be used without departing from the scope of the present invention.

As the rotor plate 17 turns, so turns the blade carrier plate 51, which causes the attached blades 61 to spin at a speed which is sufficient for mowing and shredding the vegetation with which the advancing edges of the blades 61 come in contact. In the preferred embodiment, the blade carrier plate 51 is constructed from flat, heavy, steel plate. Because of the large size of the rotatable blade carrier plate 51, a fly wheel effect is created when the rotatable blade carrier plate 51 turns, thereby conserving tractor fuel and wear and tear on the component parts of the rotary vegetation cutter 10 when used to cut a thick growth of vegetation.

In one embodiment of the invention described in the instant application, four cutting blades 61 are attached to the blade carrier 51 as shown in FIG. 6. The cutting blades 61 are attached to the blade carrier 51 by threaded fasteners 62. In the preferred embodiment other attachment means such as restrained pins may be used without departing from the scope of the disclosed invention. Use of these threaded fasteners 62 to attach the cutting blades 61 to the blade carrier 51 facilitates the removal and replacement of worn out or damaged blades 61. In one embodiment, the blades 61 are reversible, so as to get maximum life out of the cutting blades.

It has been found that no special size rubber tire is required as the relationship of the diameter of most automobile and small truck tires (13 inch to 18 inch diameter) to the diameter of the rotor 17 provides sufficient rotational speed for the blade carrier 51 (1000-1500 rpm) to spin the blades 61 fast enough to mow and shred most vegetable matter found in mowable areas. As previously indicated, it has been found that inexpensive used or worn tires may also be used as the amount of tread on the surface of a rubber tire 15 makes little difference in the operation of the disclosed invention.

Because of the nature of the contact of the rubber surface of the tire 15 with the rotor plate 17, any misalignment of the axis of rotation of the tire 15 with the center of rotation of the rotor 17 caused by bouncing or movement of the tractor with respect to the disclosed rotary vegetation cutter 10 is easily compensated for by the slippage of the outside surface of the tire 15 against the top surface of the rotor plate 17. Similarly, if the rotary vegetation cutter 10 hits a large rock or a stump and the blades 61 become unable to move, the outside surface of the rotating tire 15 simply slips against the top surface of the rotor plate 17. In the worst case, after hitting a large rock or a stump, the least expensive part of the disclosed invention, the tire 15, may have to be replaced; however, a quick look back at the rotary vegetation cutter 10 by the operator of the tractor will reveal that the rotor plate 17 is not turning and the power connection to the tractor can be disengaged. If, for some reason the drive train of the tractor comes to a sudden stop, the coefficient of sliding friction between the outside surface of the non-rotating tire 15 and the rotor plate will allow the blades 61, blade carrier plate 51 and the rotor plate 17 to continue turning until it coasts to a stop.

Those of ordinary skill in the art will recognize that there exist several other embodiments of the present invention which are not disclosed herein. Those other embodiments are specifically included in this application and are within the scope and meaning of the appended claims.

What is claimed is:

1. A gearless agricultural rotary vegetation cutter for connection to the tow bar and PTO of a tractor, said gearless agricultural rotary vegetation cutter comprising:
a power shaft connecting the PTO of the tractor to the wheel portion of a wheel and tire assembly;
said tire portion of said wheel and tire assembly being in a substantially perpendicular orientation and in rotational frictional contact with a shaft-mounted rotor plate;
said shaft-mounted rotor plate being affixed to a rotatable blade carrier plate;
a plurality of cutting blades attached to said rotatable blade carrier plate;
a drive shaft holding frame to adjustment of the rotational frictional force between said tire and said shaft mounted rotor plate;
whereby said cutting blades spin at a sufficient speed to mow/shred vegetation when rotational power from the tractor is applied through the power shaft to said tire and wheel assembly which, in turn, rotates said shaft mounted rotor-plate, said blade carrier plate and said plurality of cutting blades.

2. The rotary vegetation cutter as defined in claim 1 wherein said shaft mounted rotor plate, said rotatable blade carrier plate and said plurality of cutting blades are contained within a protective housing.

3. The rotary vegetation cutter as defined in claim 1 wherein said drive shaft holding frame is adjustably mounted to said protective housing to permit said tire to be adjustably positioned with respect to said rotor plate.

4. The cutter as defined in claim 2 further including at least one wheel attached to said protective housing.

5. The cutter as defined in claim 4 wherein at least one wheel is positioned for adjusting the height at which vegetation is cut.

6. A gearless system for providing power to an agricultural rotary vegetation cutter, said gearless system comprising:
a tractor including a PTO;
said PTO being connected to a first power transfer shaft:
said power transfer shaft being connected to a second power shaft on the agricultural rotary vegetation cutter:
a tire attached to said agricultural rotary vegetation cutter power shaft:
said tire being located in a substantially perpendicular orientation with respect to a substantially horizontal rotor plate:
said substantially horizontal rotor plate being attached to a blade carrier plate;
a plurality of cutting blades attached to said blade carrier plate;
whereby when the PTO from the tractor is engaged, said first power transfer shaft will rotate causing said second power shaft to rotate, which causes said tire to rotate which, in turn, causes said substantially horizontal rotor plate and said blade carrier plate to turn, thereby turning said plurality of cutting blades.

7. The gearless system as defined in claim 6 wherein said horizontal rotor plate, said blade carrier plate and said plurality of cutting blades are contained within a protective housing.

8. The gearless system as defined in claim 6 further including a drive shaft holding frame for adjustment of the force applied by said tire to said substantially horizontal rotor plate.

9. The gearless system as defined in claim 7 further including a least one wheel attached to said protective housing.

10. The gearless system as defined in claim 9 wherein the height of said at least one wheel is adjustably positioned for controlling the height of cut of said cutting blades.

11. A method for driving an agricultural rotary vegetation cutter comprising the steps of:
connecting a power shaft to the PTO of a tractor;
attaching a tire to said power shaft at the end opposite the end of said power shaft connected to said PTO of said tractor;
positioning said tire to be in contact with a rotor plate;
attaching said rotor plate to a blade carrier plate;
attaching cutting blades to said blade carrier plate;
whereby when said tire is rotated by power received through said power shaft, said rotor plate is turned causing said blade carrier to rotate, initiating the mowing/shredding action of said cutting blades.

12. The method as defined in claim 11 further including the stop of enclosing said rotor plate, said blade carrier plate and said cutting blades with a housing.

13. The method as defined in claim 12 further including the step of mounting said power shaft to a power shaft holding frame to regulate the force of the tire on said rotor plate.

14. The method as defined in claim 12 further including the step of hingedly mounting wheels to said housing.

15. The method as defined in claim 14 wherein said hinged mounting of said wheels can be used to regulate the height at which the vegetation is cut.
